(19) United States
(12) Patent Application Publication
(10) Pub. No.: US 2007/0094276 A1
(43) Pub. Date: Apr. 26, 2007

(54) Method for obtaining and managing restricted media content in a network of media devices

(76) Inventor: Emad S. Isaac, Woodridge, IL (US)

Correspondence Address: MOTOROLA, INC., 1303 EAST ALGONQUIN ROAD, IL01/3RD, SCHAUMBURG, IL, 60196, US

(21) Appl. No.: 11/254,301

(22) Filed: Oct. 20, 2005

(51) Int. Cl. G06F 7/00

(52) U.S. Cl. 707/100

(57) ABSTRACT

Media devices are connected to a network. Restrictive rights restrict how the media device can process restricted media content on the network. Information indicative of the restrictive rights associated with the network is stored on the network. A request is received to deliver restricted media content to a requested device, which lacks the right to process it. The stored information is used to determine which media device has the restrictive right to process the requested content, and an instruction is sent to that device. The processed content is then delivered from the determined device to the requesting device. A centralized embodiment of the network has a server connected to the media devices. Another embodiment of the network enables the media devices to obtain restricted media content suitable for the restrictive rights of the network from content providers.

### CROSS-REFERENCE TO RELATED APPLICATIONS

This application is filed concurrently with U.S. Patent Application having Express Mail No.: ED869153135U.S., Attorney Docket No. IS02019TC, and entitled “System and Method for Real-Time Processing and Distribution of Media Content in a Network of Media Devices.”

### FIELD OF THE INVENTION

This invention relates to methods for obtaining restricted media content from content providers and managing restricted media content in a network of media devices.

### BACKGROUND OF THE INVENTION

A number of electronic media devices for processing various forms of media content are known in the art. Examples of some media devices include portable electronic devices, cellular communication devices, home entertainment systems, personal computers, and vehicular entertainment systems. Examples of media content processed with such media devices include multimedia data, audio data, video data, cable broadcast data, radio broadcast data, satellite broadcast data, and television broadcast data.

Several techniques known in the art restrict processing of media content on electronic media devices. These restrictive techniques can be referred to as Digital Rights Management (DRM) schemes. Some examples of restrictive techniques include Serial Copy Management System (SCMS), Macrovision, Serial Copy Management System (SCMS), Helix DRM, Steam, iTunes™ (which incorporates Apple's FairPlay DRM for content downloaded through the iTunes™ Music Store), Windows Media DRM (WMDRM) that protects Windows Media Audio or Video content and is implemented in Windows Media Player, OMA DRM system used by the Open Mobile Alliance, Real Networks, Sony's DRM technology OpenMG, MMK Secure Stream, Digital Transmission Content Protection (DTCP), Content Protection for Recordable Media (CPRM), High-Bandwidth Digital Content Protection (HDCP), and Digital Transmission Copy Protection over Internet Protocol (DTCP-IP).

In general, restrictive techniques protect the way in which media content can be stored, copied, transferred, played, recorded, etc. on electronic media devices. For example, some restrictive techniques allow specific types of restricted media content to be played only on an authorized device and prohibits rendering of the restricted content on other devices. In other words, a user that purchases a music file can play that file on an authorized device (e.g., an iPod™), but she cannot play that file on another device, such as a different MP3 player.

In another example, some restrictive techniques limit the number of a user's media devices to which a music file can be downloaded and limit the number of times the music file can be burned to an audio CD. In some cases, however, the restrictive techniques allow the music files to be transferred to an unlimited number of the user's portable music devices.

In another example, a restrictive technique associated Microsoft Windows Media Player 9 can restrict an audio file downloaded from an Internet website. The audio file can be backed up to another computer by copying the audio file and a licensed backup file associated with it, but the Windows Media Player 9 software may restrict the number of devices that can store a copy of the audio file.

In another example, restrictive techniques prevent media content from being transferred outside a particular network or domain. For example, some Internet media protocols prevent restricted content from being transmitted outside a user's home network. In yet another example, a restricted video “rented” via the Internet must be played within a specified time period so that a media device can only store the restricted video file for a specific amount of storage time, beyond which the video file cannot be played. Typically, these types of restricted video files cannot be burned or copied. In addition, these types of restricted video files typically require a proprietary software application or utility with a specific type of decryption for processing the restricted video file on a media device.

Today, persons may own or have access to a number of media devices capable of communicating together in a network. Unfortunately, the media devices and media content on the network will typically have different restrictive techniques associated with them and, therefore, may be incompatible with each other. With all of the various media devices, media content, and restrictive techniques available, it would be advantageous to be able to manage media devices, media content, and restrictive rights on a network of media devices.

The subject matter of the present disclosure is directed to overcoming, or at least reducing the effects of, one or more of the problems set forth above.

### BRIEF DESCRIPTION OF THE DRAWINGS

FIG. 1 illustrates an embodiment of a media network according to certain teachings of the present disclosure.

FIG. 2 illustrates the media network of FIG. 1 in more detail for obtaining media content.

FIG. 3A illustrates an embodiment of a content provider manifest in chart form.

FIG. 3B illustrates an embodiment of a device manifest in chart form.

FIG. 4 illustrates, in flowchart form, an embodiment of a process for obtaining media content from a content provider according to one aspect of the disclosed network.

FIG. 5 again illustrates the media network of FIG. 1 in more detail for managing restricted media content and media devices on the network.

FIG. 6 illustrates an embodiment of a media content manifest in chart form.

FIG. 7 illustrates, in flowchart form, an embodiment of a process for managing restricted media content and media devices according to another aspect of the disclosed network.

While the disclosed systems and methods are susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112

### DETAILED DESCRIPTION

A centralized embodiment of a network for managing restricted media content includes a server and a plurality of media devices connected to the network by a plurality of communication paths. The restricted media content is stored on the network and is associated with restrictive rights that restrict processing of the media content with the media devices. Information indicative of the restrictive rights is stored at the server. A request is received at the server to deliver restricted media content to a requested media device, which lacks the restrictive right to process the requested media content. Therefore, the server determines from the stored information which media device has the restrictive right to process the requested media content. The server sends an instruction to the determined media device to process the requested media content in accordance with the restrictive right. The processed media content is then delivered from the determined media device to the requested media device.

A decentralized or distributed embodiment of the network lacks a central server. The media devices actively connected to the distributed network store the information of the restrictive rights and share that information with each other. The acts of receiving the request, determining which media device, and instructing the determined media device are handled by one or more the active media devices on the decentralized network.

Another embodiment of the network enables the media devices to obtain restricted media content from external sources that provide restricted media content. The network stores information indicative of restrictive rights for the restricted media content provided by the external sources. In addition, the network stores information indicative of restrictive rights for the media devices on the network and the restricted media content stored on those devices. When a request to obtain restricted media content is received, the first and second information is compared to determine from which external source to obtain the requested media content. Then, the requested media content is obtained via the network from the determined source. Therefore, based on the information of the external sources, media devices, and existing restricted media content, the source that has been determined provides the requested media content with a restrictive right suitable for processing with at least one of the media devices on the network.

The foregoing is not intended to summarize each potential embodiment or every aspect of the present disclosure. Let us now refer to the figures to describe the invention in greater detail.

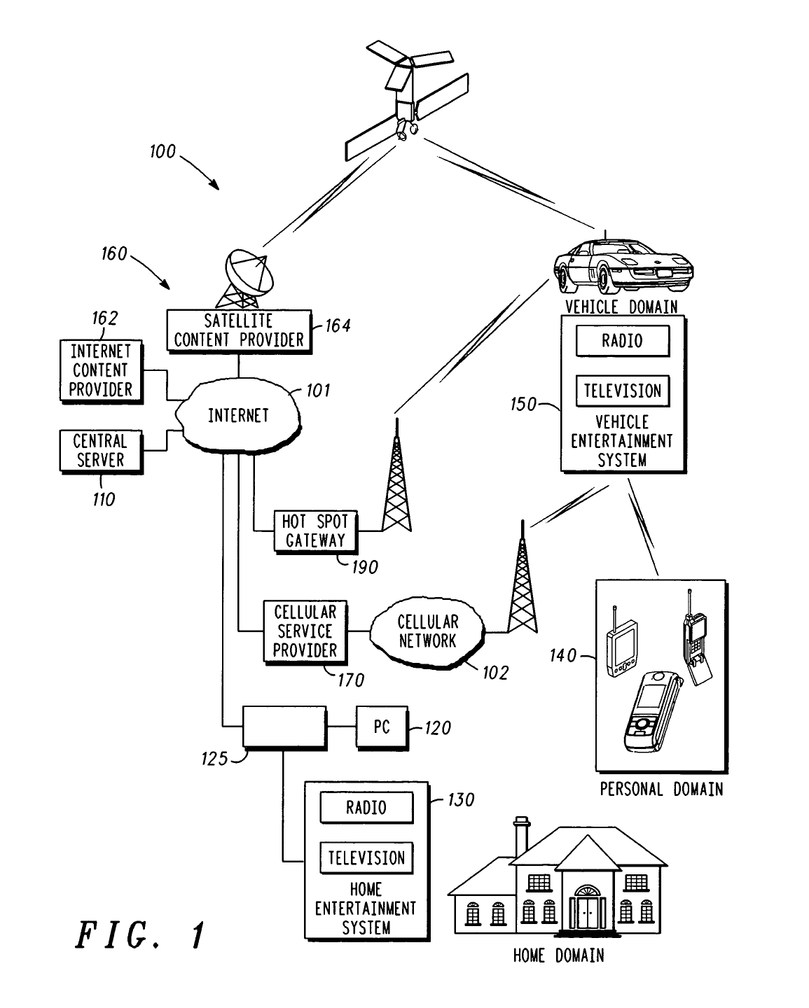

Referring to FIG. 1, an embodiment of a media network 100 according to certain teachings of the present disclosure is illustrated. The present embodiment of the media network 100 illustrates a variety of possibilities available for the systems and methods of the present disclosure. The media network 100 includes a plurality of media devices 120, 130, 140, and 150 capable of delivering media content (e.g., audio, video, data, etc.) to users in various domains. For example, one media device 150 can be in a vehicular domain and can be incorporated into a vehicle's head unit or entertainment system. One example of such a vehicle device 150 is referred to as a Telematic system, such as disclosed in U.S. patent application Ser. No. 11/118,528, filed Apr. 29, 2005(Dkt. No. IS01598TC), which is incorporated herein by reference in its entirety. Other media devices 120 and 130 can be in a home domain and can be a music server, a personal computer, or a home entertainment system, for example. Still another media device 140 can be in a personal domain and can be a portable electronic device, such as a personal digital assistant (PDA), a digital music player, an iPod™, or a portable phone, for example. It is understood that other media devices known in the art can also be used in these and other domains of the network 10.

In accordance with embodiments of the invention, the media devices 120-150 can share media content with one another and can receive media content from any of a plurality of sources or content providers 160, such as an Internet content provider 162, a satellite content provider 164, a cable content provider (not shown), and a radio content provider (not shown). For example, the media devices 120-150 can receive broadcast content (audio and/or video) from the satellite content provider 164 and can receive broadcast content via radio signals from local content broadcasters (not shown). In another example, the media devices 120-150 can receive stored content from the Internet content provider 162, which can provide stored music or video content to users. If the media device is a portable or mobile unit (such as the vehicle media device 150 or the portable media device 140), the media device may also be able to receive stored content using a cellular content provider 170 and cellular network 102 or using a home gateway 125 or a hot spot gateway 190 through a short-range communication system known in the art.

Using various communication links of the network 100, the media devices 120-150 can exchange and transfer data, instructions, and media content between the media devices 120-150 and providers 160-180. In various embodiments, the media devices 120-150 can also communicate with one another in the network 100 using any of a number of communication techniques known in the art. For example, one or more of the media devices 120-150 can include wireless transceivers capable of establishing wireless communication links through a wireless communication system, such as a cellular network 102. The cellular network 102 can operate according to wireless communication protocols known in the art, such as a Global System for Mobile Communications (GSM) protocol, a Code Division Multiple Access (CDMA) protocol, or a Time Division Multiple Access (TDMA) protocol. The cellular network 102 can be further coupled to the Internet 101 by the cellular content provider 170 or other wired network, allowing a cellular device to connect with another media device on the network 100. For example, the vehicle device 150 can be connected through the cellular network 102, the provider 170, and the Internet 101 to the home media devices 120, 130.

In additional examples, some of the media devices 120-150 can include wireless transceivers capable of establishing wireless communication links through short-range wireless communication systems or networks, including, but not limited to, a Bluetooth™ communication system and an IEEE 802.11 communication system. For example, the portable device 140 can establish direct communication with the vehicle device 150 using Bluetooth™ technology. In another example, a short-range wireless transceiver in the vehicle device 150 can establish direct wireless communication to another media device 120, 130 in the home through the home gateway 125 or can establish indirect wireless communication to another media device 120, 130 in the home through the hot spot gateway 190.

In one embodiment, the media network 100 is a centralized network and includes a central server 110, as shown in FIG. 1. The central server 110 hosts the communications between the media devices 120-150 and manages the distribution and processing of media content between media devices. The central server 110 can communicate with the media devices 120-150 through a combination of communication links that are wireless or wired. For example, the central server 110 can be an independent component of the network 100 that is connected to a high-speed Internet 101 and connected in turn to the media devices 120-150 by the various communication links disclosed herein.

In another embodiment, the media network 100 is a decentralized or distributed network and does not include central server 110. Instead, functions for managing the media content and media devices 120-150 can be incorporated into or distributed among the content providers, such as the Internet music provider 160, the cellular service provider 170, etc. Alternatively, functions for managing the media content and media devices 120-150 can reside locally in one or more of the media devices 120-150, as discussed in more detail below. Additional details concerning the media network 100 of the present disclosure are disclosed in U.S. patent application Ser. No. 11/118,528, filed Apr. 29, 2005(Dkt. No. IS01598TC), which has been incorporated herein in its entirety.

Now that the media network has been described, discussion now turns to how the media network obtains media content from content providers.

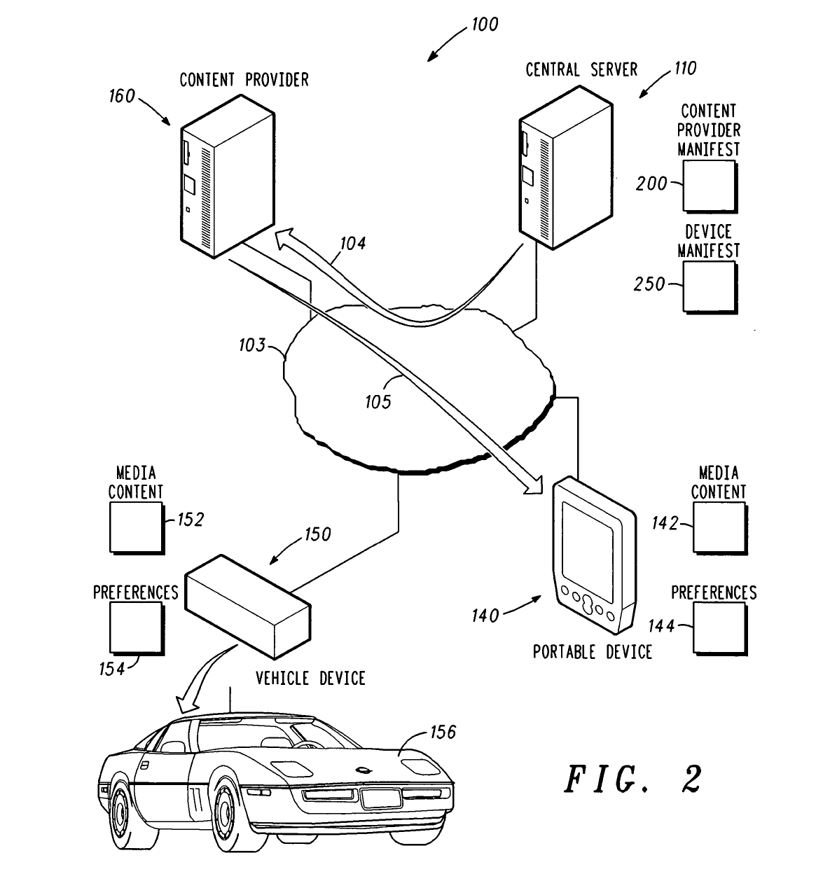

Referring to FIG. 2, certain aspects of the media network 100 are illustrated in more detail. Again, the network 100 is centralized and includes central server 110. The network 100 also includes personal device 140 and vehicle device 150, which are active on the network 100. A content provider 160 is also available on the network 100. It is understood, however, that the disclosed network 100 can have any number of media devices and content providers. The server 110, personal device 140, vehicle device 150, and content provider 160 are connected together by various network paths, which are only schematically represented in FIG. 2 by element 103 and which can involve communication using the Internet, cellular wireless, Bluetooth™, IEEE 802.11, and combinations thereof, for example.

In the present example, the server 110 is a remote server connected to network 103 by a high-speed Internet path, and the content provider 160 is an external source of media content, such as an Internet server hosting a website for purchasing music. The personal device 140 is a portable music player connecting to network 103 by a cellular wireless communication path, which in turn connects with the Internet by techniques known the art. The vehicle device 150 is a Telematic system in a vehicle 156 that connects to network 103 by a cellular wireless communication path, which in turn connects with the Internet by techniques known the art. The server 110 and media devices 140 and 150 may also be capable of connecting to one another using short-range communication, such as Bluetooth™ or IEEE 802.11, for example.

The portable music player 140 stores media content in file 142 and preferences in file 144, and the vehicle device 150 stores media content in file 152 and preferences in file 154. Although not shown, it is possible that the central server 110 also stores media content and preferences and can process such content. The media content in files 142 and 152 includes media files, such as music, video, etc. Some of the media content in files 142 and 152 is restricted (i.e., associated with a restrictive technique or Digital Rights Management (DRM) scheme). As previously noted, restrictive techniques or DRM schemes (referred to herein as restrictive rights) contain information that restricts the way in which restricted media content can be stored, copied, played, rendered, transferred, etc. on media devices 140 and 150.

The central server 110 maintains a content provider manifest 200 and a device manifest 250. The central server 110 obtains information for these manifests 200 and 250 by monitoring the media devices 140 and 150 active on the network 110 using techniques known in the art, such as Universal Plug and Play (UPnP™) technology. The content provider manifest 200 contains information concerning various content providers, such as Internet music provider 160, available via the network 100. The device manifest 250 lists information about the media devices 140 and 150 on the network 100, such as the device's ID, domain, network location, and preferences. The device manifest 250 also contains what types of media content the devices 140 and 150 have the restrictive rights to process, which can involve rights to download, transfer, copy, burn, store, encode, decode, transcode, parse, render, or steam the media content, for example.

The central server 110 uses the content provider manifest 200 and the device manifest 250 to obtain (restricted or unrestricted) media content from content providers. For example, the server 110 analyzes information in the manifests 200 and 250 to purchase and download a song from Internet music provider 160. Based on the server's analysis of the information in these manifests 200 and 250, the song downloaded from the Internet music provider 160 is suitable for the restrictive rights and preferences associated with the media devices 140 and 150 on the network 100. Before discussing how the central server 110 obtains media content on the network 100, however, details of the content provider manifest 200 and the device manifest 250 will be discussed first.

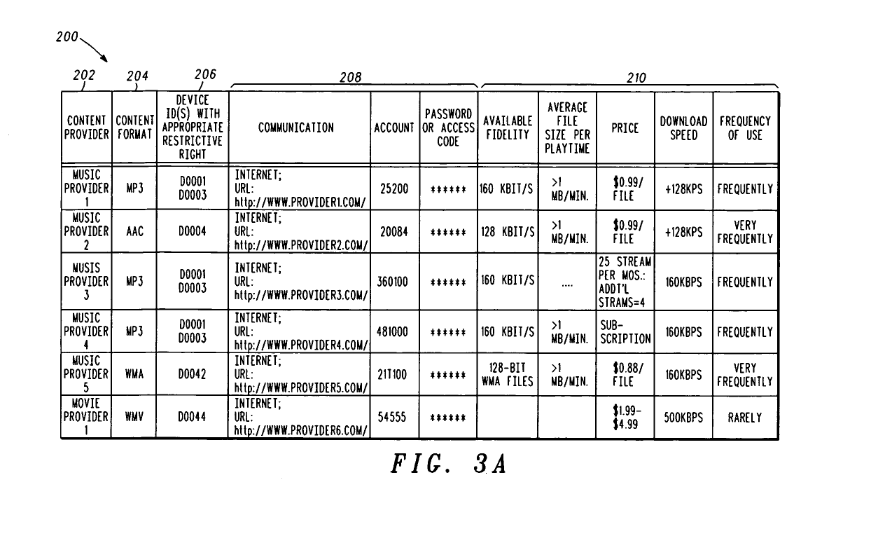

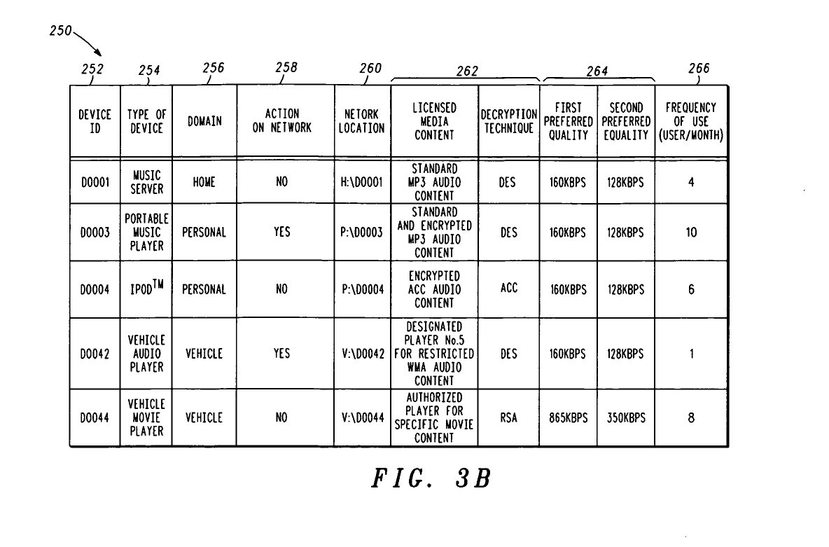

An embodiment of the content provider manifest 200 is illustrated in FIG. 3A. Although shown in chart form for illustrative purposes, it is understood that the content provider manifest 200 and other manifests disclosed herein can be maintained in any manner known in the art, such as part of a database associated with a server. The manifest 200 lists various content providers (fields 202), the format of the media content available from the providers (fields 204), the media devices (e.g., 140) associated with the content providers as defined by a device ID (fields 206), information on how to communicate with and obtain (e.g., purchase) media content from the content providers (fields 208), and the quality of media content and services available from the content providers (fields 210). The information in the content provider manifest 200 can be preconfigured and updated automatically or manually using techniques known in the art.

The content providers in fields 202 can provide music, movies, or any of the other forms of media content disclosed herein. The content formats listed in fields 204 pertain to the encoding, type of file, or encryption for the media content available from the content providers. For example, one music provider may provide music files having standard MP3 encoding, while another music provider may provide encrypted music files.

In general, the devices listed in fields 206 include those having appropriate software applications for processing the available media content and, more particularly, to those having specific restrictive rights to process restricted media content from the provider. For instance, the media devices listed in fields 206 may be able to decrypt encrypted content from the associated content provider or may be designated as an authorized device for restricted content from the provider. For example, the media device “D0042” listed for content provider “Music Provider 5” may be a specially designated player for the “WMA” music file available from that content provider.

The communication information in fields 208 indicates how the central server 110 connects or communicates with the content providers. For example, a content provider may be a server hosting a website having a Universal Resource Locator (URL) accessible via the Internet. To communicate with the provider, the central server 110 uses a web browser or other like application to automatically connect with the content provider and purchase media content from the content provider using URL calls or other techniques. The fields 208 also include an account number and a password as necessary to purchase the media content.

The information in fields 210 describe the quality of media content and services available from the content provider and include the average fidelity of the media content, the average file size per playtime of the media content, the price of the media content, and the download speed available from the content provider. In addition, fields 210 include the frequency with which the content provider has been used. The central server 110 uses the information in these fields 210 to select a particular content provider based on user-defined preferences when initiating a purchase of media content on behalf of the user. It will be appreciated that, depending on a particular implementation, the content provider manifest 200 can include other information than that shown in FIG. 3A.

As noted previously, the content provider manifest 200 of FIG. 3A is used in conjunction with the device manifest 250, an embodiment of which is shown in FIG. 3B. The device manifest 250 lists various media devices by ID (fields 252), the type of device it is (fields 254), its domain in the network (e.g., home, vehicle, portable) (fields 256), whether it is currently active on the network (fields 258), and its location or path on the network (fields 260).

In fields 262, the device manifest 250 lists the type of media content that the associated device can either freely process or has the restrictive rights to process. Although only one type of media content is shown for each media device listed, it is understood that each media device may process more than one type of media content. In addition, fields 262 list decryption techniques used by the media devices, such as the Data Encryption Standard (DES) and the RSA algorithms known in the art.

As noted previously, a media device with restrictive rights can be (1) restricted to processing only a particular type of media content, (2) designated as an authorized media device for processing certain restricted media content (even if other media devices on the network are so capable), or (3) limited to using only a particular software application to process specific restricted media content (even if other software is so capable). Thus, the information in fields 262 contain such restrictions to the extent they are pertinent for a particular media device. Otherwise, for unrestricted media content, the information in a particular field 262 indicates that its associated media device is generally capable of processing the listed types of media content (without restriction).

Information in fields 264 indicates the user's preferences for media content on the devices, such as first and second preferred fidelity levels for the media content. Other preferences, such as preferred price, supplier/vendor, availability, download speed, etc., can also be provided in these fields 264.

Information in fields 266 includes historical data showing the frequency of use for the media devices. This historical data (shown here as uses per month) is used to determine which media device is most logical to store specific restricted media content. For example, using the historical data, the server 110 could determine that a frequently used media device is a preferred location to store new media content over a less frequently used media device. The historical data in field 266 can also be used to manage which media devices should logically be designated as players for restricted media content. For example, if restrictive rights 262 restrict media content to a specific number of designated media devices, the central server 110 may de-authorize an infrequently used device to free up restrictive rights or designations for other devices.

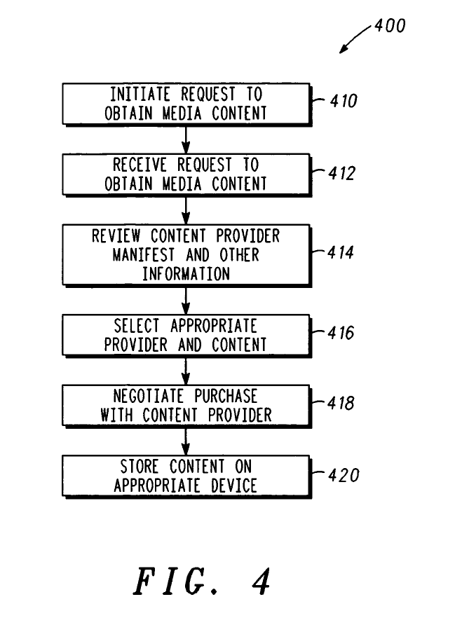

With an understanding of the content provider manifest 200 and the device manifest 250 of FIGS. 3A-3B, discussion now turns to a flow chart illustration 400 in FIG. 4 of how the disclosed network obtains media content from content providers. The user initiates a request at a media device to obtain media content (Block 410). The server 110 receives the request from the media device (Block 412). The server then reviews information in the content provider manifest 200 concerning the available content providers, reviews information in the device manifest 250 concerning the media devices active on the network, and reviews information about the media device that initiated the request (if necessary) (Block 414). After reviewing this information, the server then selects the appropriate type of media content and the appropriate content provider 160 (Block 416) for the user's request.

The selections of the appropriate media content and content provider can be based on several determinations. For example, the content provider can be selected based on the frequency of use of that content provider in the content provider manifest 200 (FIG. 3A). In addition, the selection can be based on the quality of content and service (such as fidelity 210) in content provider manifest 200 (FIG. 3A) viewed in light of preferences (such as fidelity 264) in the device manifest 250 (FIG. 3B). Of course, the content provider and media content are selected to be consistent with the types of media content that can be processed by at least one of the media devices on the network, as reflected in fields 206 (FIG. 3A).

After making such determinations, the server goes to the selected content provider to purchase or otherwise obtain (if purchase is unnecessary) the desired media content on behalf of the user (Block 418). After purchasing the media content, the server downloads the media content for storage (Block 420).

The media content obtained may or may not be restricted (i.e., associated with restrictive rights). However, if it is restricted, the selected content provider offers media content that is compatible with the restrictive rights of at least one media device, as described above. Preferably, the server stores restricted media content at a media device having the appropriate restrictive rights for rendering it, although this is not strictly necessary. Typically, the restrictive rights, which can be in the form of encryption keys or other files, are stored with or as part of the restricted media content. Therefore, storing restricted media content on a media device having the restrictive rights to render the content can prevent the need for additional processing steps, as discussed in more detail below.

Now that details of the process of FIG. 4 for obtaining media content from content providers have been discussed, an illustrative example of that process will be discussed with reference to FIG. 2.

In the exemplary arrangement of the network 100 of FIG. 2, the user may be listening to streamed music on her portable music player 140 from a broadcast provider (not shown), and she may hear a song that she wants to purchase. Using an interface on the music player 140, the user initiates a request to purchase the desired song. The purchase of the song is then handled automatically by the server 110 using the information in the content provider and device manifests 200 and 250, as explained above and detailed below.

In general, the server 110 purchases the song based on an analysis of which device initiated the purchase and based on information contained in the content provider and device manifests 200 and 250. For example, from the device manifest 250 of FIG. 3B, the server 110 determines the device ID (field 252) for the music player 140 where the request was made. If the music player 140 is a frequently used device, the server 110 then determines the preferred fidelity (field 264) and the format of media content that the music player 140 is capable of playing or is restricted to playing (field 262). Then, from the content provider manifest 200 of FIG. 3A, the server 110 locates a content provider (field 202) associated with the device ID (field 206) of the music player 140. There may be more than one possible content provider, and the server can, for example, compare the preferred fidelity (field 264; FIG. 3B) with the available fidelity along with other qualities (fields 210) to determine a preferred content provider from the manifest 200. Assume in this example that content provider 160 is chosen.

Once a preferred content provider is determined, the server 110 handles the purchase from the provider 160 using the contact and account information (fields 208) of the content provider manifest 200. As schematically shown in FIG. 2, the central server 110 handles the purchase using an Internet link 104, for example. Once purchased, the song is then downloaded to somewhere in the network 100 from the provider 160, as explained below.

In general, it is possible for the purchased song to be downloaded and stored elsewhere on the network 100 than on the requesting music player 140. For example, the purchased song can be stored at the central server 110 or the vehicle device 150, even though they may lack the restrictive rights to render the song. Preferably, however, the purchased song is stored on the media device having the appropriate restrictive rights to process the song, which may typically be the requesting device (i.e., music player 140) as shown in FIG. 2. For example, suppose the song is purchase from iTunes™ (as the content provider 160) and is downloaded to the media content file 142 of an iPod™ (as the music player 140) using communication link 105.

The following example illustrate why it is preferred that the song be stored on a media device having the restrictive right to process it. Songs from the Internet music provider iTunes™ 160 are FairPlay-protected and are regular MP4 container files, that produce an encrypted AAC audio stream. iTunes™ 160 generates a random user key each time the user purchases a song. This random user key is used to encrypt a master key, which is stored with the MP4 container file of the song and which is required to decrypt the encrypted AAC audio stream of the song. The random user key is stored in an encrypted key repository (not shown) at the user's iPod™ 140. To render the restricted song stored in the file 142, the iPod™ 140 obtains the random user key from its repository to decrypt the master key in the MP4 container file of the song, and the decrypted master key is in turn used to decrypt the encrypted AAC audio stream of the song.

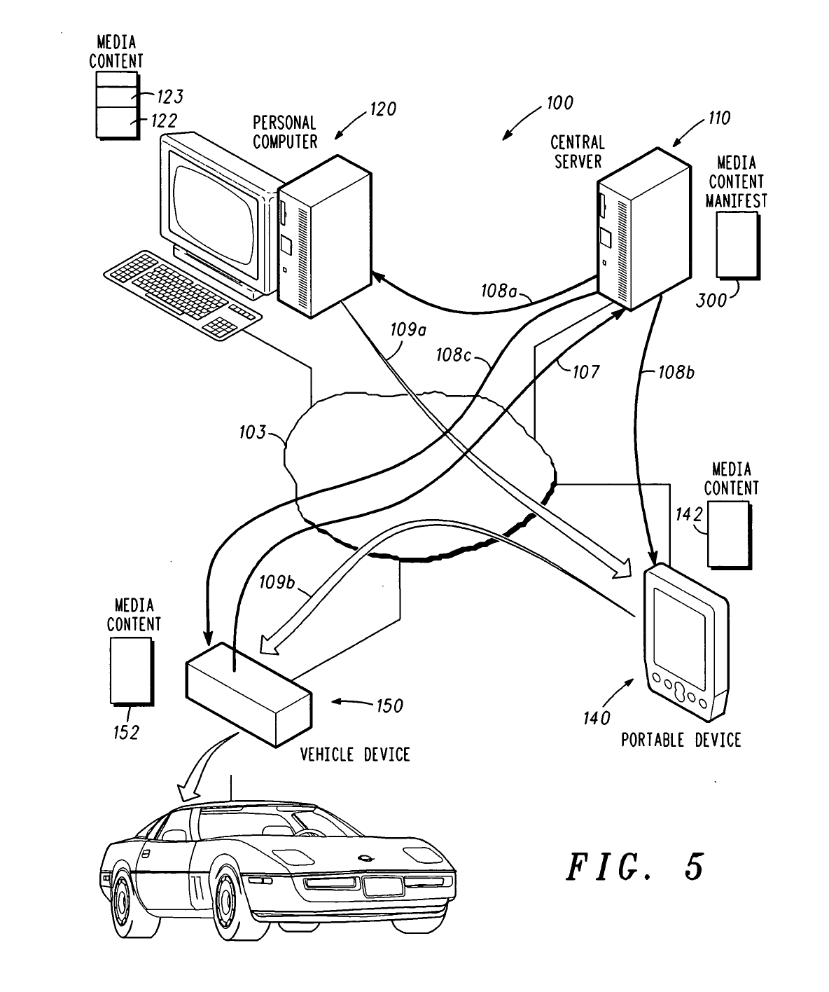

As evidenced by the above example, storing restricted media content (e.g., a song from iTunes™) on a media device (e.g., in iPod™) having the restrictive right to process the media content may prevent the need for the server 110 or other media devices to perform various steps, such as transferring keys or other files between media devices. Storing media content on a media device that does not have the restrictive right to process it, however, can be accomplished and may present few management difficulties depending on the type of media content and the restrictive right involved. In fact, an example of such a situation is discussed below in conjunction with FIG. 5.

The preceding discussion has focused on how the network 100 obtains (e.g., purchases) restricted and unrestricted media content from content providers and how that content is stored somewhere on the network. Now that the network 100 has restricted media content, the discussion focuses on how processing of restricted media content is managed on the network 100. FIG. 5 essentially shows network 100 of FIG. 2 and has the same central server 110, music player 140, and vehicle device 150. Instead of a content provider, however, another media device (i.e., personal computer) 120 is active on the network 100. The personal computer 120 stores a restricted song 123 in its media content file 122.

The central server 110 maintains a media content manifest 300, which lists the media content (either restricted or not) available from the active media devices 120, 140 and 150. For example, information about the restricted song 123, its location on the network (i.e., at personal computer 120), its format, and other information are stored in the content manifest 300. When a user requests the restricted song 123 at one of the media devices 120, 140 or 150, the server 110 uses the information in the media content manifest 300 to manage how that restricted song 123 is processed.

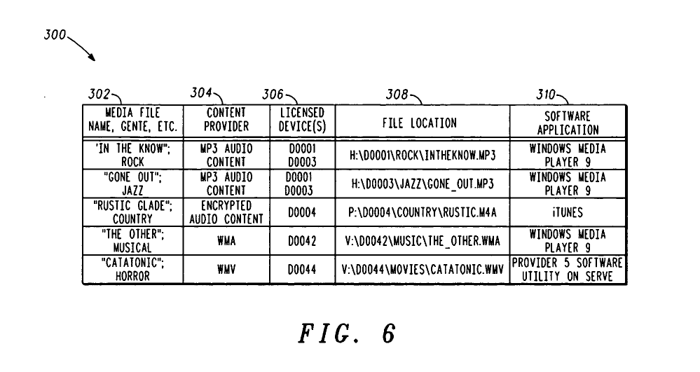

Information in the media content manifest 300 is provided in an embodiment of FIG. 6. The manifest 300 lists the name, genre, etc. (fields 302) and the type of file (filed 304) for all of media content available from the media devices currently active on the network. Fields 306 lists those media devices that are capable of rendering the associated media content. Preferably, information in the manifest 300 is dynamically maintained so that the list of available media content (fields 302) is continually updated depending on the media devices (fields 306) currently active on the media network. Additional information in the manifest 300 can include the network location (fields 308) of associated media content and the software application or rendering engine (fields 310) for rendering the associated media content.

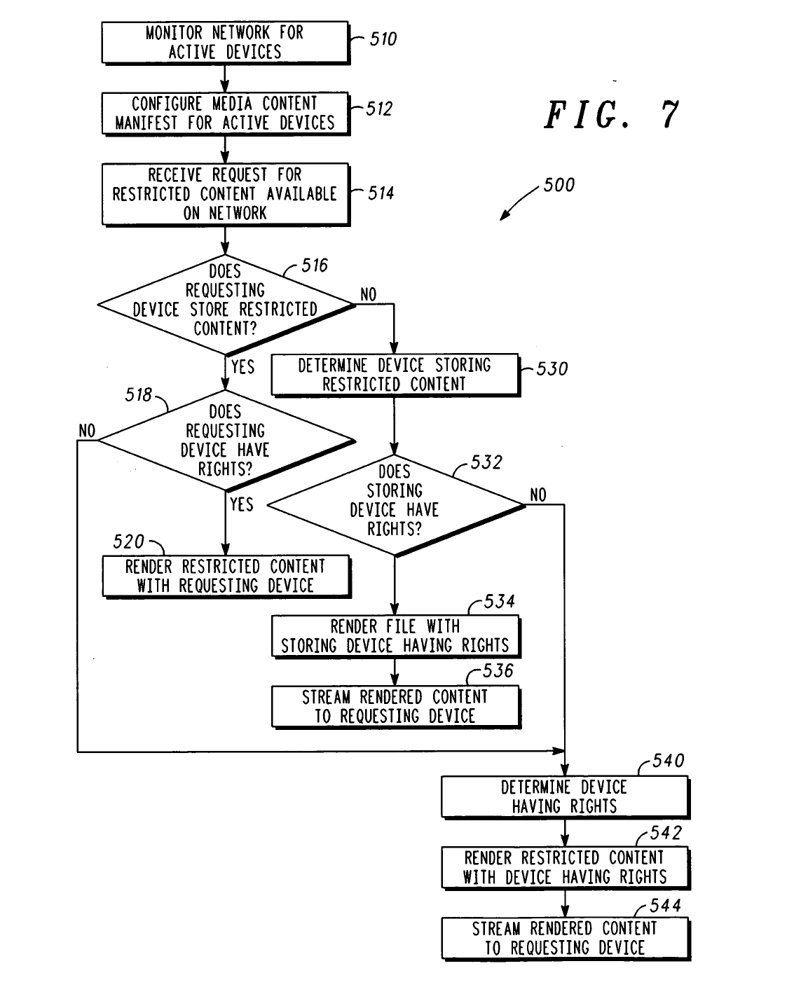

Now that the media content manifest 300 has been described, discussion now turns to a flowchart illustration 500 in FIG. 7 of how the network manages restricted media content when a user requests restricted media content. The server 110 monitors the network for active media devices (Block 510) and lists information of the available media content in the media content manifest 300 (FIG. 6) (Block 512). The server receives a request when the user at one of the media devices requests restricted media content (e.g., requests to listen to a restricted song) (Block 514) and makes one or more determinations described below.

In general, the requesting media device may or may not store the requested media content and may or may not have the appropriate restrictive rights to render the requested media content. Therefore, the server 110 first determines whether the requesting media device stores the restricted media content (Block 516) and, if so, whether the requesting media device also has the appropriate restrictive rights to render the restricted media content (Block 518). If this is the case, the requesting media device is allowed to render the requested media file and deliver it to the user (Block 520).

If the requesting media device, however, does store the restricted media content in Block 516 but lacks the appropriate restrictive rights to render it, the server 110 determines from the media content manifest 300 (FIG. 6) which media device has the restrictive right to render the requested media content (Block 540). Then, the server instructs the media device storing the media content to transfer it to the determined media device (using techniques in the art) and instructs the determined media device having the restrictive rights to render it (Block 542). Finally, the server instructs the determined media device to stream the rendered media content to the requesting media device (Block 544).

If the requesting media device does not store the restricted file in Block 516, then the server 110 determines from the media content manifest 300 (FIG. 6) which device on the network is storing the restricted media content (Block 530) and determines if the storing device has the restrictive rights to render it (Block 532). If the storing media device does have the restrictive rights, the server 110 instructs the storing media device to render the restricted media content (Block 534) and stream the rendered media content to the requesting media device (Block 536).

If the storing media device does not have the restrictive rights at Block 540, the sever 110 determines from the content manifest 300 (FIG. 6) which media device has the restrictive rights (Block 540), and the server instructs the storing device to transfer the restricted media content to the determined media device for rendering (Block 542). Finally, the server 110 instructs the determined media device to stream the rendered media content to the requesting media device (Block 544).

Although not shown in FIG. 7, managing restricted media content can also use additional determinations disclosed in U.S. Patent Application having Express Mail No. ______, Attorney Docket No. IS02019TC, which is incorporated herein by reference. These additional determinations take into the processing capabilities, the communication throughput, and the processor usage of the media devices to determine how to deliver the requested media content to the requesting media device.

Now that details of the process for managing restricted media content have been discussed, an illustrative example of that process will be provided with reference to FIG. 5. As discussed previously, personal computer 120 stores restricted song 123 in file 122, and information on the song 123 is maintained in the media content manifest 300. Each media device 120, 140 and 150 active on the network 100 can access or receive information in the manifest 300 so that the user can access from each device 120, 140 and 150 which songs are currently available on the network 100.

In the present example, the user access the available songs in the manifest 300 with an interface on her vehicle device 150 and makes a request 107 to hear the restricted song 123 stored on personal computer 120. The server 110 receives the request 107 and determines from information in manifest 300 the location of the requested song 123 and which media device has the restrictive right to render it. To complicate the present example, the restricted song 123 may be protected by Helix DRM. The storing device (i.e., computer 120) may not be a Helix designated device, and the requesting device (i.e., vehicle device 150) may not be such a Helix designated device. The personal player 140, however, may be such Helix designated device so that it has the restrictive right to render the Helix protected song 123.

To process the song 123 in this situation, the server 110 sends an instruction 108a to the computer 120 to transfer the requested song 123 to the music player 140 via a communication link 109a. The song 123 is transferred using techniques known in the art and without rendering or otherwise processing the song in a way that would violate the restrictive right associated with it. Then, the server 110 sends an instruction 108b to the music player 120 to render the transferred song 123 and stream the rendered song to the vehicle device 140 via a communication link 109b. Finally, the server 110 sends an instruction 108c to the vehicle device 150 to receive the streamed song 123 over the communication link 109b.

Although the network 100 shown in FIGS. 1, 2, and 5 has central server 110, the functions and features of the server 110 can be incorporated into any of the media devices of the network 100. Furthermore, the functions and features of the server 110 can be distributed among the various media devices of the network 100 so that the disclosed network is essentially a decentralized or distributed network. Operation of such a decentralized network will be substantially similar to the operation of the centralized network 100 disclosed herein with the exception that the media devices will share operation in the decentralized network.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of managing restricted media content with a server and a plurality of media devices, the server and the media devices connected to a network by a plurality of communication paths, wherein restrictive rights restrict how the media devices can process the restricted media content, the method comprising:
storing information at the server indicative of the restrictive rights associated with the media devices;
receiving a request at the server for delivery of restricted media content to a requested media device, wherein the requested media device lacks the restrictive right to process the requested media content;
determining from the information stored at the server which media device has the restrictive right to process the requested media content;
sending an instruction from the server to the determined media device to process the requested media content according to the restrictive right of the requested media content;
delivering the processed media content from the determined media device to the requested media device.

2. The method of claim 1, wherein the media devices are selected from the group consisting of a portable electronic device, a portable music player, a cellular communication device, a home entertainment system, a personal computer, and a vehicular entertainment system.

3. The method of claim 1, wherein the media content is selected from the group consisting of multi-media data, audio data, video data, cable broadcast data, radio broadcast data, satellite broadcast data, and television broadcast data.

4. The method of claim 1, wherein the restrictive right is selected from the group consisting of:
a format for restricted media content that a media device can process;
an encryption for restricted media content that a media device can decrypt;
a license for restricted media content that a media device can process;
a designation of whether a media device is authorized to process restricted media content;
a number of times that restricted media content can be processed by a media device; and
a length of time that restricted media content can be processed by a media device.

5. The method of claim 1, wherein the information stored at the server comprises information identifying a location of the restricted media content on the network, and wherein the act of determining further comprises:
determining the location of the requested media content on the network; and
transferring the requested media content from the location to the determined media device if the determined media device is not the location.

6. The method of claim 1, wherein the act of delivering comprises:
processing the restricted media content at the determined media device according to the restrictive right; and
sending the processed media content from the determined media device to the requested media device or to another media device for further processing before sending to the requested media device.

7. The method of claim 1, further comprising monitoring the media devices actively connected to the network to update the information at the server.

8. A method of managing restricted media content with a plurality of media devices connected to a network by a plurality of communication paths, wherein restrictive rights restrict how the media devices can process the restricted media content, the method comprising:
storing information indicative of the restrictive rights associated with the media devices;
receiving a request for delivery of restricted media content to a requested media device, wherein the requested media device lacks the restrictive right to process the requested media content;
determining from the stored information which media device has the restrictive right to process the requested media content;
instructing the determined media device to process the requested media content according to the restrictive right of the requested media content; and
delivering the processed media content from the determined media device to the requested media device.

9. The method of claim 8, wherein the media devices are selected from the group consisting of a portable electronic device, a portable music player, a cellular communication device, a home entertainment system, a personal computer, and a vehicular entertainment system.

10. The method of claim 8, wherein the media content is selected from the group consisting of multi-media data, audio data, video data, cable broadcast data, radio broadcast data, satellite broadcast data, and television broadcast data.

11. The method of claim 8, wherein the restrictive right comprises an indication selected from the group consisting of:
a format for restricted media content that a media device can process;
an encryption for restricted media content that a media device can decrypt;
a license for restricted media content that a media device can process;
a designation of whether a media device is authorized to process restricted media content;
a number of times that restricted media content can be processed by a media device; and
a length of time that restricted media content can be processed by a media device.

12. The method of claim 8, wherein the stored information comprises information identifying a location of the restricted media content on the network, and wherein the act of determining further comprises:
determining the location of the requested media content on the network; and
transferring the requested media content from the location to the determined media device if the determined media device is not the location.

13. The method of claim 8, wherein the act of delivering comprises:
processing the restricted media content at the determined media device according to the restrictive right; and
sending the processed media content from the determined media device to the requested media device or to another media device for further processing before sending to the requested media device.

14. The method of claim 8, further comprising sharing the stored information between the media devices actively connected to the network, wherein the acts of receiving the request, determining which media device, and instructing the determined media device are handled by one or more the active media devices.

15. A method of obtaining restricted media content from external sources of restricted media content for a plurality of media devices, the media devices connected to a network by a plurality of communication paths, wherein restrictive rights restrict how the media devices can process the restricted media content, the method comprising:
storing first information indicative of restrictive rights associated with the external sources;
storing second information indicative of restrictive rights associated with the media devices;
receiving a request at a requesting media device to obtain restricted media content;
determining from which external source to obtain the requested media content by comparing the first information to the second information, wherein the determined external source provides the requested media content with a restrictive right suitable for processing with at least one of the media devices on the network; and
obtaining the requested media content via the network from the determined external source.

16. The method of claim 15, wherein the media devices are selected from the group consisting of a portable electronic device, a portable music player, a cellular communication device, a home entertainment system, a personal computer, and a vehicular entertainment system.

17. The method of claim 15, wherein the media content is selected from the group consisting of multi-media data, audio data, video data, cable broadcast data, radio broadcast data, satellite broadcast data, and television broadcast data.

18. The method of claim 15, wherein the restrictive right is selected from the group consisting of:
a format for restricted media content that a media device can process;
an encryption for restricted media content that a media device can decrypt;
a license for restricted media content that a media device can process;
a designation of whether a media device is authorized to process restricted media content;
a number of times that restricted media content can be processed by a media device; and
a length of time that restricted media content can be processed by a media device.

19. The method of claim 15, wherein the first information further comprises information indicative of a quality of media content or service available from the external source, and wherein the second information further comprises a preferred quality of media content or service.

20. The method of claim 15, wherein the act of obtaining the requested media content via the network from the determined external source comprises automatically negotiating a transaction for the requested media content with the external source.
